(19) United States
(12) Patent Application Publication
(10) Pub. No.: US 2003/0122730 A1
(43) Pub. Date: Jul. 3, 2003

(54) System for displaying moving images on a container

(76) Inventors: Sidney E. Frank, New Rochelle, NY (US); Bruce M. Bakerman, Stamford, CT (US)

Correspondence Address: MORGAN & FINNEGAN, L.L.P., 345 Park Avenue, New York, NY, 10154-0053, US

(21) Appl. No.: 10/033,514

(22) Filed: Dec. 27, 2001

(51) Int. Cl. G09G 5/00

(52) U.S. Cl. 345/1.1

(57) ABSTRACT

A system for actively displaying moving images on a container sidewall, which comprises a display unit, control unit, and power unit. The system is secured within the interior of the container, while the display screen is flush with the container sidewall so that the outer shape and other characteristics of the container resemble a regular container. The control system may be used to allow automatic control or manual control of the underlying system.

### FIELD OF INVENTION

The present invention relates to a system for displaying moving images, and more particularly to a system for actively displaying moving images from the side of a container sidewall from within the interior of the container.

### BACKGROUND OF THE INVENTION

Food and beverage containers, such as alcohol containers in the form of bottles and cans, are typically cylindrical in shape. Many producers of food and beverage, especially producers of alcoholic drinks, create distinct designs of container shapes that usually appeal to the aesthetic senses of the consumers and thereby create an aura of class and charm for the particular food or beverage. The container may be made of materials such as glass, plastic, sheet metal and/or the like. Typically, the sidewall is provided with a colorful label identifying the manufacturer and the contents of the container. The label may be printed on the sidewall of the container itself, or on a paper or plastic sleeve which is then pasted on the container sidewall.

A major function of the label on food or beverage containers is to attract the attention of a potential purchaser. The label can be a powerful advertising medium which can dramatically increase sales and revenues. Therefore, manufacturers compete to make their food and beverage containers stand out to attract as much attention as possible. Currently, the vast majority of food and beverage containers, such as spirit containers, use static images such as labels on the sidewalls of the containers.

Moving or otherwise dynamic images, however, have a much higher potential for attracting potential purchasers. However, most of the known mechanisms fail to provide a decent system for displaying dynamic images. For example, some have suggested the use of shrink-wrapping to enclose a light emitting diode (LED) between the shrink-wrapped film and the product container to backlight an image on the film. However, such a system merely results in the LED being turned on and off according to a specified sequence.

Further, some systems change the outer characteristics of the container, such as the shape thereof. For example, in some cases, the shape of the container may be changed because there are LED's extruding out from underneath the shrink-wrapped film. Clearly, such a container is not desirable because of its unaesthetic appearance.

Therefore, it is desirable to have a system that is able to display dynamic images from the sidewall of any container, while maintaining the regular/classic shape and other outer characteristics of the container. Furthermore, it is desirable to have a device that enables users to view moving images and/or graphics as a feature that is ancillary to the main function of the device.

### SUMMARY OF THE INVENTION

Accordingly, it is an objective of the present invention to provide a dynamic display system for displaying high quality color images on a container under electronic control. According to another embodiment, the dynamic images may be provided with an accompanying audio.

In another embodiment, the dynamic display system may incorporate image sequencing. In yet another embodiment, the invention may include a container with a display which can show a plurality of images in a variety of sequences.

In yet another embodiment, a device is disclosed that enables users to view moving images and/or graphics as a feature that is ancillary to the main function of the device. The device may come as a complete system (e.g., a Compact Disc (CD) player with a moving image displayer on its sides) that has a primary function (e.g., playing music) and a secondary function (displaying moving images from its sides).

Furthermore, in another embodiment, a balloon that displays images therefrom is disclosed. The balloon may display dynamic and/or static images therefrom flying floating in the air.

Other objectives and advantages of the invention will become apparent from the following description of the invention.

In short, the present invention relates to a moving image display system and method for actively displaying images on the side of a container, where the system is housed in the interior thereof. By placing the dynamic display system in the interior of the container, the outer characteristics of the container are not altered, and the classic shape and feel of the individual containers are maintained.

The moving image display system of the present invention comprises a display system, a control system and a power system. The control system instructs the display system to display a particular sequence of images, or display varying number of images, or to turn the display system on or off. The control system may be an automatic control system or a manual control system. An automatic control system instructs the display system, using instructions stored in memory. The manual control system has a user control for the user to input instructions. The manual control system may comprise one or more buttons on the container itself. The buttons may be on/off button, or an image selection button. The manual control system may also comprise a remote control system, where the input buttons are on a separate unit and the instructions are communicated to the control system via a wireless communication system. Because the system may also comprise a means for playing music, the manual control system may also be used to change the type of music and/or control the playing music.

The power system comprises one or more portable power means available in the art, such as batteries, adapter and/or the like. The dynamic images displayed on the display system may not be limited to moving images such as video or animation, but could also include a sequence of different colored or flashing lights, or words for advertising purposes.

### BRIEF DESCRIPTION OF DRAWINGS

FIG. 1 provides a front view of a container incorporating a system for actively displaying images therein.

FIG. 2 is a side view that shows the interior of the container incorporating the dynamic display unit in a portion of its interior.

FIG. 3 is a side view that shows the interior of the container incorporating the dynamic display unit, wherein the unit's power source is also located within the interior.

FIG. 4 illustrates an embodiment of the present invention wherein the dynamic display system incorporates an electroluminescent lamp.

FIG. 5 illustrates another embodiment of the present invention wherein the dynamic display system incorporates a Liquid Crystal Display.

FIG. 6 illustrates another embodiment of the present invention wherein the dynamic display system incorporates a white projector screen.

FIG. 7 illustrates another embodiment of the container with a button input unit used therein.

FIG. 8 illustrates a remote control unit for use in yet another embodiment of the present invention.

FIG. 9 is a block diagram depicting one embodiment of the system of the present invention.

FIG. 10 illustrates a balloon that provides a display of moving as well as static images therefrom.

### DETAILED DESCRIPTION OF THE DRAWINGS

With reference to the Figures, various embodiments of the system for displaying moving images on the sidewalls of a container will now be described in greater detail. It is to be understood that the tasks shown in the Figures and described in this Detailed Description can be sequenced in many different orders to achieve the desired result. The order or sequence of tasks illustrated in the Figures is merely intended to be exemplary of the concepts defined herein.

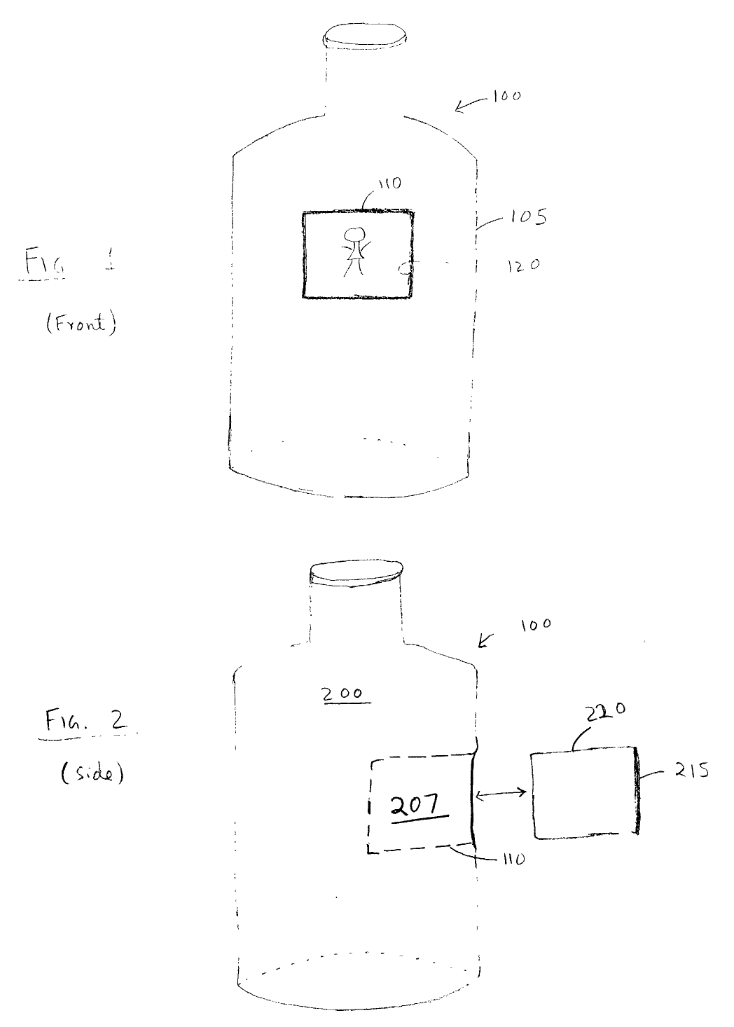

FIG. 1 depicts a container 100, incorporating the dynamic display unit of the present invention. The container 100 has a cylindrical sidewall 105, but could be provided with sidewalls of any geometric shape. The sidewall 110 is constructed with an opening 110, so that the dynamic display module 120 of the present invention may fit securely therein. It is also possible to have an opening 110 such that the dynamic display module 120 is securely attached to the sidewall 105 with a clasp or some other similar mechanism. The opening 110 and dynamic display module 120 are located at a location where an advertising label is normally placed on a container of this kind, so that the container 100 resembles a regular/normal container with an ordinary label thereon. However, the difference between the container 100 and a regular container is that the container 100 is capable of actively displaying dynamic and moving images through the opening 110 in its sidewall 105, whereas a regular container with an ordinary label displays the static image printed on its label.

It should be noted that while the present discussion uses the example of a container to illustrate one embodiment of the invention, various other types of objects may be used in the alternate embodiments. For example, in one embodiment, a television set may be used such that one or more dynamic display module 120 are secured from its sidewalls. Thus, users may watch regular programs from the television's screen and then view other moving images (such as advertisements from the owners' of the television set) from the sidewalls. In another example, a CD player may allow viewing of moving images from its sidewalls as a second feature.

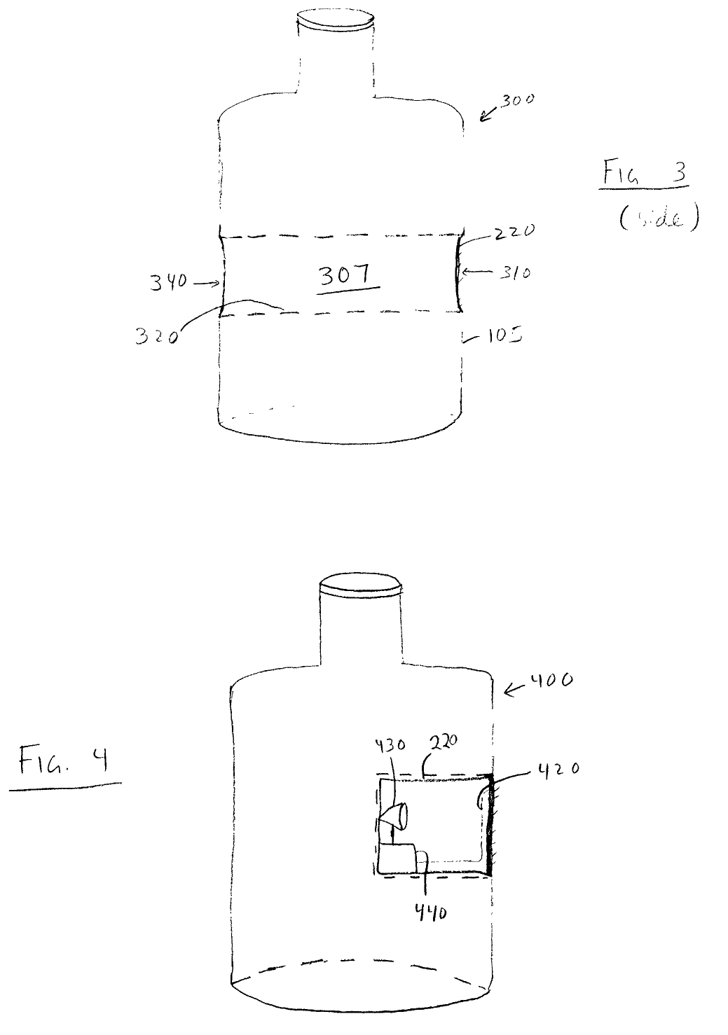

FIG. 2 depicts the interior 200 of container 100, as seen from the side. The container 100 has an opening 110 in the sidewall 105. The opening 110 leads to a separate enclosure or compartment 207 that is located within the container 100. The dynamic display module 220 is housed in the enclosure 207 within the container 100. As a result, the display means 215, which is the face of the dynamic display module 220, fits securely (i.e., snuggly) in the opening 110. The display means 215 lies substantially in the same plane (i.e., substantially flush) as the sidewall 105, though it is possible to provide the display means such that it is parallel to the sidewall 105 but not flush therewith. Components for the present invention, such as said display means 215, control means, and power means, are part of the dynamic display module 220. In one embodiment, the dynamic display module 220 may be made waterproof on the exterior because it is in constant contact with the contents of the container 100, such as beverages or other liquids.

FIG. 3 disclosed another embodiment of the interior of the container 300 with dynamic display module 220, as seen from the side. The container 300 has two openings, a first opening 310 and a second opening 340, in the sidewall 105, which lie directly opposite from each other. A tube 320 (made with the same material as the container 300), having the length of the diameter of the cylindrical body of the container 300, and having a cross section shape consistent with the openings 310, 340 is used to connect the two openings 310, 340. The tube is a hollow cavity in the body of the container 300, which may be used to house the dynamic display module 220 in accordance with one embodiment of the present invention. One end of the dynamic display module 220 is placed at first opening 310, so that the display means 215 of the dynamic display module 220 lies substantially flush with the opening 310 in the sidewall 105. The other end of the dynamic display module 220 is substantially flush with the second opening 340. Sources for providing power to the dynamic display module 220 may be placed adjacent to the second end of the dynamic display module 220, adjacent to the second opening 340, so that replaceable power sources, such as batteries, may be placed or removed therefrom without removing the dynamic display module 220 from the container. In another embodiment, the second opening 340 may be used to hold a second display means 215, where the dynamic display module 220 has two display means 215 on it two ends. In this embodiment, the power sources and the rest of the circuitry lies in the center of the hollow compartment 307.

Various embodiments are possible, wherein the second opening 340 is utilized for some purpose or the other. For example, in one embodiment, second opening 340 is only large enough to allow a pin to pass therethrough, such that the pin is used to nudge and push the dynamic display module 220 out of the hollow compartment 307.

In addition, container 300 may be provided with grooves in the empty cavity 320 in container 300 to allow the dynamic display module 220 to be securely snapped into place within the container 300.

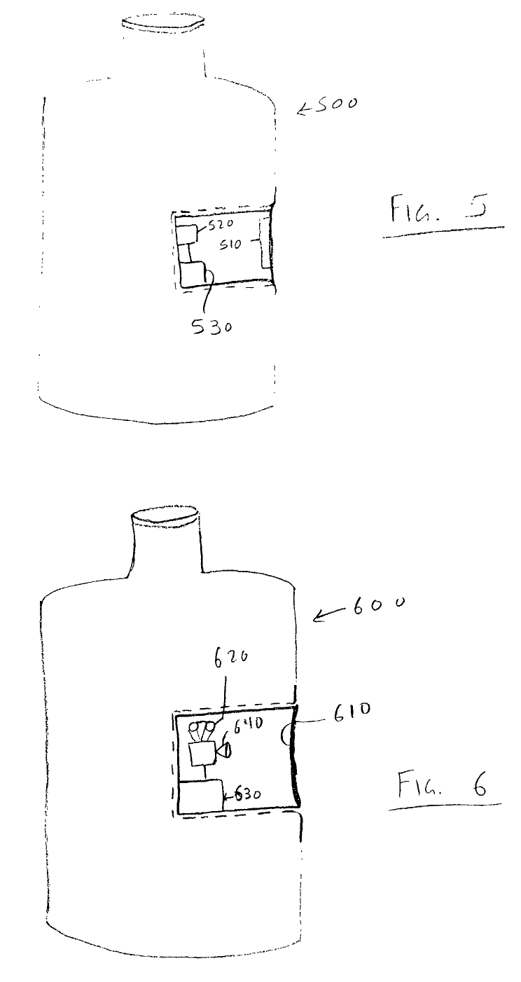

FIGS. 4-7 depict several display embodiments of the present invention. The different display embodiments are shown with the interior 200. These different display embodiments can also be configured to function in disjointed components to allow use of the housing embodiment described in conjunction with FIG. 3.

FIG. 4 depicts one display embodiment of the present invention. The container 100 has the dynamic display module 220 incorporated within. One or more images are recorded on a film 420 or other transparent or other such material, and are placed at the front face of the dynamic display module 220. The film 420 may be in the form of a film roll such that images are displayed through the dynamic display means 220 when the film 420 is unrolled in front of the EL lamps that backlight the film. A light source 430, which may be an eletroluminscent light source, is placed behind the film 420 to illuminate it.

The electroluminescent (EL) lamp 430 may be any EL lamp known in the art and can be manufactured in various complex shapes. The active display design incorporated herein uses EL lamps to backlight black and white or color images on otherwise transparent film. The size, shape and configuration of the EL lamp are customized to match the image format for a particular display implementation. The EL lamp intensity is a function of voltage and frequency, and so the higher the voltage and frequency, the brighter the EL lamp.

The EL lamp power supply is required to generate 80-120 volts A.C. from, for example, a 3.0 volts D.C. battery. Numerous vendors supply integrated circuit devices for EL lamps used in watches and cellular phone applications which are also suitable for the applications described herein.

Using the EL lamp display, the backlit images are made visible. The control system 440 is responsible for controlling the film 420 and the light source 430 to actively change the visual output. The control system 440 changes the image being backlit by the light source 430. Alternately, the control system 440 may also change the duty cycle of the light source 430 to create a dimming or strobing effect.

FIG. 5 illustrates another display embodiment of the present invention. The container 500 has the dynamic display module 220 incorporated therein. A Liquid Crystal Display (LCD) screen 510 is located at the front portion of the dynamic display module 220, flush with the sidewall of the container 500. A memory unit 520 is in communication with the LCD screen 510, wherein the memory 510 contains data for a variety of digital images or digital video. A control system 530 is in communication with the memory 520 to provide instructions regarding the digital images or clips of digital video that must be shown on the LCD screen 510. The control system 530 is also in communication with the LCD screen 510 to control the display aspects of the LCD screen 510, such as the brightness or contrast of the image being played on the LCD screen 510.

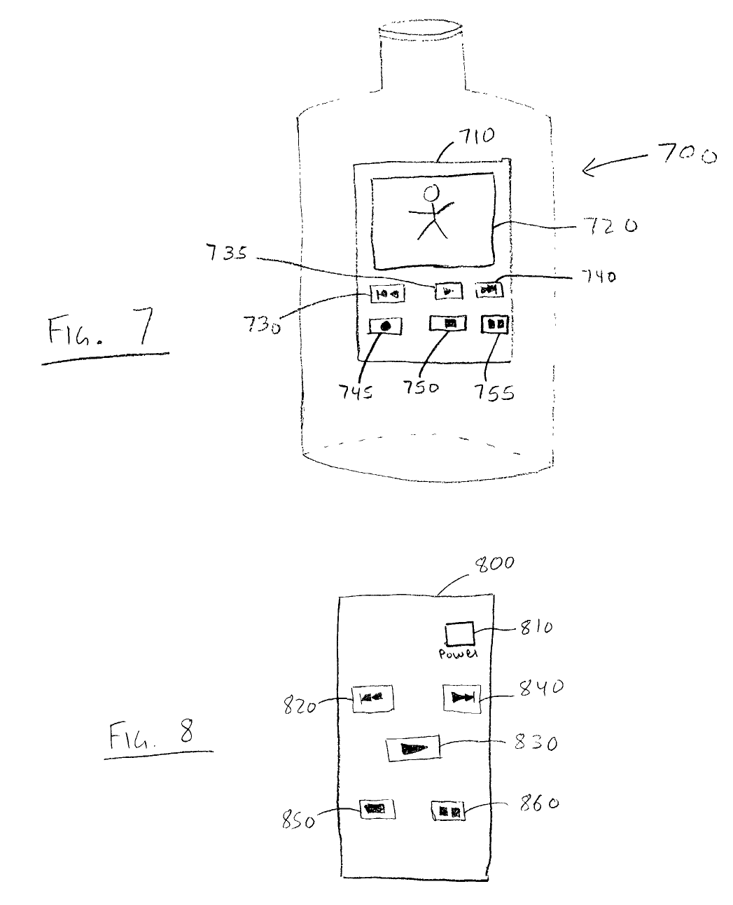

FIG. 6 depicts another display embodiment of the present invention. The container 600 has the dynamic display module 220 incorporated therein. A white projector screen 610 is placed at the front portion of the dynamic display module 220, flush with the sidewall of the container 600. A projector 620 is placed at the back portion of the dynamic display module 220. The projector 620, such as a 35 mm film projector, has an internal light source and one or more images printed on a film. The internal light source projects a light on the images, and the light passes through the film and a lens 640, and lands onto the projector screen 610, which causes the display of the images. The images on film may be a collection of distinct images, or a clip of a motion picture. A control system 630 is in communication with the projector 620. The control system 630 controls the various functionalities of the projector 620, such as turning it on or off, controlling the brightness of the internal light source, and/or the like.

The operation of the present invention may be controlled automatically or manually. In one embodiment, where automatic control is used, a memory in communication with the control system may contain one or more instructions to operate the dynamic display module 220. Instructions may include turning the unit on or off, changing the image being displayed, playing a video clip stored in memory, and dimming or brightening the display system.

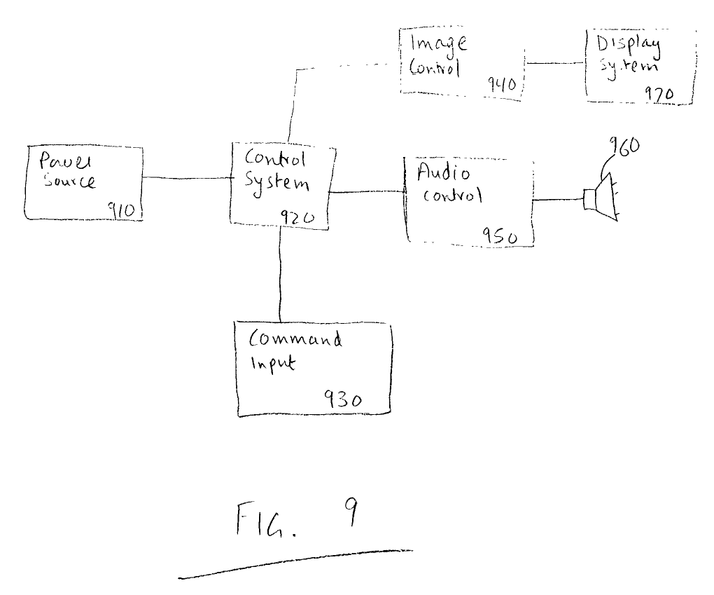

In another embodiment, where manual control is preferred, the user may input commands to control the present invention. FIG. 7 depicts the container 700 with the present invention using one such manual control device. While this embodiment is described using the LCD video display as the display embodiment to illustrate the manual control, it should be understood that this manual control can be configured for use on any of the display embodiments discussed herein. The container 700 has an opening in the sidewall 710, where one face of the dynamic display module 220 fits securely into the opening. The LCD screen 720 displays one or more images or video clips. Below the LCD screen, buttons are provided that may be used to control the LCD display. For example, button 735 begins the playback of a video clip, and button 750 stops the playback. Buttons 730 and 740 are used for rewinding and fast forwarding when a video clip is being played, or they may be used to change the image displayed when a sequence of images is being played. Button 755 is used to pause the playback of a video clip, and button 745 is the on/off switch for this unit of the present invention. Because it is important that the present invention does not change the outer shape and feel of the container, the surfaces of the buttons are also made substantially flush with the sidewall of the container. According to one embodiment, the buttons may be made of the same material as the container to ensure that the buttons blend in with the background and/or the sidewall of the container 700.

FIG. 8 depicts a wireless hand held remote control unit 800 for controlling the dynamic display module 220. The remote control 800 communicates with a unit of the dynamic display module 220 using infrared (IR) or radio frequency (RF) technology. Similarly to the system described in conjunction with FIG. 7, LCD video display is used to illustrate the remote control system, although it should be understood that this manual control may be configured for use on any of the display embodiments discussed previously.

The buttons on the remote control unit operate similarly to the buttons described in FIG. 7. For example, button 830 begins the playback of a video clip, whereas button 850 stops the playback. Buttons 820 and 840 are used to rewind and fast forward when a video clip is being played, or may be used to change the image being displayed. Button 860 is used to pause the playback of a video clip, and button 810 is the on/off switch.

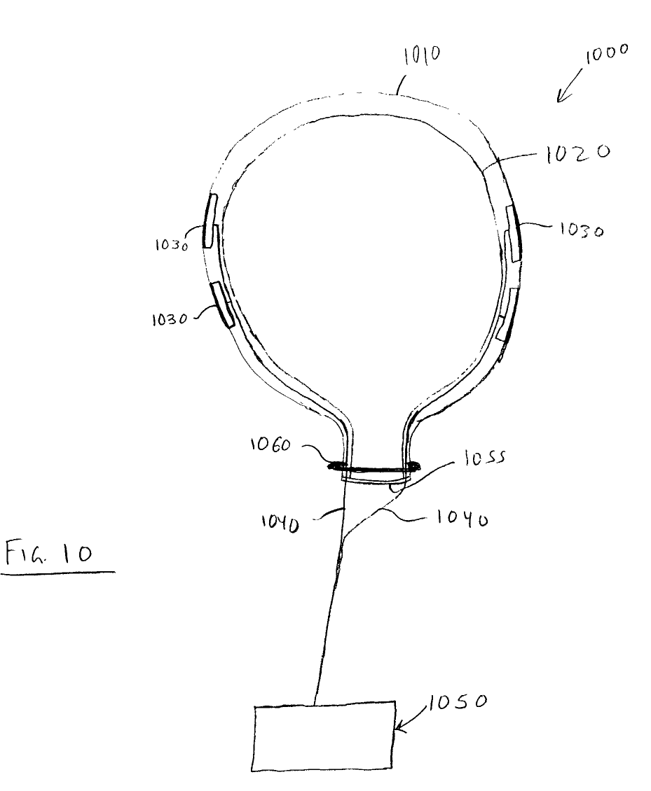

FIG. 9 is a block diagram that illustrates the components of the dynamic display module 220. A power source 910, such as a battery, powers the control system 920, which in turn transmits power to the rest of the systems. The command input 930 is in communication with the control system 920, and transmits one or more instructions on the operation of the image or audio systems to the control system 920. As mentioned previously, if automatic control is used in the present invention, then the command input 930 also comprises a memory containing one or more instructions. If, however, manual control is used in the present invention, then the command input 930 includes a button control system that may further comprise a remote control system.

Control system 920 is capable of interpreting instructions from the command input 930 and operates the image control 940 and audio control 950 accordingly. Image control 940 may control one or more images or video clips, while the audio control 950 may operate under a number of modulation schemes, such as amplitude modulation (AM), frequency modulation (FM), or pulse width modulation (PWM). The speaker 960 may be a piezoelectric speaker or any other portable speaker known in the art. The display system 970, as discussed previously, may be one of more image films, together with one or more electroluminescent lamps situated behind the image films for backlight, or one or more Liquid Crystal Display screens, displaying images recorded on a memory, or one or more projector screen, wherein one or more images are projected onto the display screen.

FIG. 10 depicts a balloon that incorporates a mechanism for displaying images therefrom. The image displaying balloon 1000 comprises an exterior balloon 1010 that is preferably constructed from a non-conducting, yet elastic and flexible, material. Some examples of possible materials for the external balloon 1010 include rubber, soft plastic, and/or the like. An interior balloon 1020 is placed within the exterior balloon 1010. Similar, to the exterior balloon 1010, the interior balloon 1020 is also preferably constructed from a non-conducting, yet elastic and flexible, material.

One or more display mechanisms 1030 for displaying images therefrom are attached to the exterior balloon 1010, such that when images are displayed from the display mechanisms 1030 these images are visible outside the image displaying balloon 1000. As discussed above, the display mechanisms 1030 may be configured to provide a feed of moving images. In another embodiment, it is possible to use the display mechanisms 1030 to output a live video feed. In yet another embodiment, the display mechanisms 1030 is used to output static images.

The display mechanisms 1030 are connected to an external circuit box 1050, using wires 1040. The wires 1040 are made from any conductive material. It is possible to achieve the present invention without using actual wires 1040, but instead utilizing any conductive material that connects the display mechanisms 1030 to the external circuit box 1050. The external circuit box 1050 comprises the power sources and the necessary electronic circuitry for display of the moving or static images on the display mechanisms 1030.

According to the present invention, the interior balloon 1020 is inflated with helium, air or some other gas, which results in inflating of the external balloon 1010, and thus the entire image displaying balloon 1000. The lower end 1055 of the image displaying balloon 1000 is clamped with a light-weight clamp 1060 to prevent deflation of the interior balloon 1020. According to one embodiment, the light-weight clamp 1060 may be made out of aluminum or some alloy comprising aluminum, because aluminum is a light and ductile metal, which is sufficiently strong. It should be noted that it is possible to construct the present image displaying balloon 1000 such that only the interior balloon 1020 is clamped to prevent deflation thereof.

According to another embodiment, the image displaying balloon 1000 may be constructed so as to provide sound along with the display of moving and/or static images. In this embodiment, the image displaying balloon 1000 comprises audio equipment, such as at least one speaker, circuitry for controlling the sound quality, and/or the like. It should be noted that the audio equipment may alternately be placed in the circuit box 1050.

While FIG. 10 depicts one embodiment of the present invention using balloons, various other embodiments are possible, within the scope of the present invention. For example, it is possible to construct the present invention such that only one balloon is used in the image displaying balloon 1000. In this embodiment, the display mechanisms 1030 are attached to the balloon from either the interior thereof or on the exterior thereof. The display mechanisms 1030 may be connected to the circuit box 1050 using wires 1040, or using a line of conductive material deposit on the balloon's surface that extends from the display mechanism 1030 to the circuit box 1050. Where the display mechanisms 1030 are attached to the exterior of the balloon the connection from the display mechanisms 1030 to the circuit box 1050 must be insulated.

In another embodiment, the display mechanisms 1030 may be attached to the exterior surface of the interior balloon 1020, such that the display mechanisms 1030 lie in the space between the interior balloon 1020 and the exterior balloon 1010.

As noted in the above discussion, the display mechanisms 1030 may be ordinary EL lamps, a projector screen system or any other device that can be used to display moving or static images.

In another embodiment, the interior balloon 1020 may simply be knotted together to prevent deflation thereof. In yet another embodiment, the exterior balloon 1010 may be sealed by simply knotting it. Thus, as is apparent, the scope of the present invention is not limited by the mechanism for securing the contents inside the interior balloon 1020 or the exterior balloon 1010, or for preventing deflation of the image displaying balloon 1000.

In yet another embodiment, the display mechanisms 1030 may be detachable from the surface on which they are attached to allow reuse of the display mechanisms 1030 in other image displaying balloons 1000 and/or other devices. Further, the circuit box 1050 may also be built as a tiny chip with power sources to allow its enclosure in the image displaying balloon 1000, in a user's pocket, and/or the like. Alternately, the circuit box 1050 may be constructed to allow a user to carry it along with him, such as by clipping the circuit box 1050 to a user belt, and/or the like. As is apparent, various embodiments are possible within the spirit of the of the present invention.

The backbone of the present invention is the electronic circuit substrate. The electronic circuit substrate consists of the etched traces on a flexible circuit board material. The electronic circuit components (integrated circuits, passive components, battery, etc.) are mounted to the circuit board to create an assembly. The flexible circuit board is designed to the requirements of the custom shape of the particular implementation. Packaging development for present invention may include selection of sealing/laminating materials to enclose the assembly, selection of the lamination technique for the various internal components of the present invention and selection of the lamination technique for attaching the display to the container.

Variations of the present device and method that may occur and still fall within the scope of the invention are definition of the display means, shape and location of the container, definition of image sequencing requirements, definition of audio requirements and selection of activation method.

It is therefore apparent that the described apparatus has inherent advantages over the prior art. While certain preferred embodiments of the invention have been illustrated for the purpose of this disclosure, numerous changes in the arrangement and construction of parts or elements may be made by those skilled in the art, which changes are embodied within the scope and spirit of the present invention as defined by the appended claims.

What is claimed is:

1. A system for displaying a moving image, comprising:
a display system;
a container having a sidewall, said sidewall having a first opening thereon; and
an interior compartment located within said container, said interior compartment accessible from said first opening on said sidewall, said display system housed in said interior compartment,
wherein said display system comprises:
a first display unit for displaying a image thereon, said first display unit securely displayed from said first opening on said sidewall, said first display unit being parallel to the plane of said sidewall;
a control unit for controlling display of said image on said first display unit; and
a power unit for providing power to cause display of said image on said first display unit.

2. The system of claim 1, further comprising an audio generation unit for producing at least one sound in conjunction with the image being displayed.

3. The system of claim 2, wherein said audio generation unit further comprises a piezoelectric disk or a speaker for broadcasting said sound being generated.

4. The system of claim 3, wherein said control unit comprises an automated controller capable of changing the image displayed by said first display unit and sound produced by said audio generation unit in accordance with a programmed sequence that is in either a random or a predetermined order.

5. The system of claim 4, wherein said automated controller further comprises a memory in communication with said automated controller, said memory storing said programmed sequence of images displayed and sound produced.

6. The system of claim 5, wherein said sidewall has a second opening, said second opening being vertically across from said first opening, wherein said display system comprises a second display unit, said second display unit securely displayed from said second opening on said sidewall.

7. The display system of claim 1, wherein said first display unit comprises at least one projector screen for displaying the image being projected thereon from within the container.

8. The display system of claim 1, wherein said first display unit comprises at least one image film, and at least one electroluminescent lamp situated behind said image films.

9. The display system of claim 1, wherein said first display unit comprises at least one Liquid Crystal Display screen for displaying the image recorded on a memory, wherein said memory is coupled to said Liquid Crystal Display screen.

10. The display system of claim 1, wherein said control unit comprises a manual control unit that allows a user to manually change the image displayed by said first display unit and sound produced by said audio unit.

11. The display system of claim 10, wherein said manual control unit comprises of at least one button control on said sidewall for facilitating manual selection of audio-visual output from said display system.

12. The display system of claim 10, wherein said manual control unit further comprises a remote control unit to allow usage of a remote control device.

13. The display system of claim 1, wherein said power unit is a battery device.

14. The display system of claim 1, wherein said interior compartment has a second opening that is located diametrically opposite to said first opening in said sidewall, wherein the power unit is accessible from said second opening.

15. A container displaying a moving image from a sidewall thereof, the container having an interior housing cavity to house a display system therein, the display system comprising:
a display unit for displaying said moving image thereon, said display unit substantially lying in the plane of said sidewall such that it appears visually flush with the sidewall;
a controller device in communication with said display unit for controlling display of said image on said display unit; and
a power unit for providing power to cause display of said image on said display unit,
wherein said interior housing cavity has two diametrically opposite openings in said sidewall, wherein the display unit is secured from one of said openings of the interior housing cavity.

16. A display system for displaying a motion picture on a container sidewall, the container having an interior housing cavity to house the display system therein, the display system comprising:
a display means for displaying said image thereon, said display means attached from a first end of the interior housing cavity such that the display means lies substantially flush with the container sidewall;
a control means for controlling display of said image on said display means, said control means housed in the interior housing cavity; and
a power means for powering display of said image on said display means, said power means accessible from a second end of the interior housing cavity,
wherein said first end and said second end of the interior housing cavity is located diametrically opposite to each other on said container sidewall.

17. The display system of claim 16, further comprising a sound generation means for producing at least one sound in conjunction with the motion picture being displayed.

18. The display system of claim 17, wherein said control means further comprises an automated controller capable of changing the motion picture displayed by said display means and sound produced by said sound generation unit in accordance with a programmed sequence.

19. The display system of claim 18, wherein said wherein said automated controller further comprises a memory in communication with said automated controller, said memory storing said programmed sequence of images displayed and sound produced.

20. An image-displaying system, comprising:
an exterior balloon;
an interior balloon located within said exterior balloon, wherein inflating of said interior balloon causes said exterior balloon to stretch along therewith;
at least one image displaying means for displaying images outside of said image-displaying system, said image displaying means attached to said exterior balloon; and
an electronic circuit means to control said image displaying means, wherein said electronic circuit means is located exterior to said exterior balloon.

21. The image-displaying system of claim 20, wherein image displaying means is attached from the interior surface of said exterior balloon.

22. The image-displaying system of claim 20, further comprising wiring means for connecting said electronic circuit means to said image displaying means.

23. An image-displaying system, comprising:
a balloon;
at least one image displaying means for displaying images outside of said image-displaying system, said image displaying means attached to said balloon; and
an electronic circuit means to control said image displaying means, wherein said electronic circuit means is located exterior to said balloon, said at least one image displaying means being coupled to said electronic circuit means.
